(19) United States
(12) Patent Application Publication
(10) Pub. No.: US 2008/0115853 A1
(43) Pub. Date: May 22, 2008

(54) Woven fiber connectable debris carrier

(75) Inventor: Maurice Snipes, Bloomfield, NJ (US)

Correspondence Address: Maurice Snipes, 395 Franklin Street, Bloomfield, NJ, 07003, US

(73) Assignee: Mr. Maurice Snipes, Bloomfield, NJ (US)

(21) Appl. No.: 11/985,434

(22) Filed: Nov. 15, 2007

Related U.S. Application Data
(60) Provisional application No. 60/845,871, filed on Nov. 20, 2006.

(51) Int. Cl. B65F 1/14; B65B 67/00

(52) U.S. Cl. 141/10; 383/7; 383/4

(57) ABSTRACT

The present invention relates to a disposable woven fiber connectible debris carrier. The purpose of the debris carrier is to simplify the clean-up of debris associated with dry-wall and plaster demolition, outside ground work, and similar applications. The invention may protect the floor of a room or cover the ground while serving as a collection tool for construction or other debris that can then be easily carried and disposed of using the debris carrier.

### BACKGROUND OF THE INVENTION

1. Field of the Invention

The present invention relates generally to devices for the disposal of debris and more specifically it relates to a woven fiber connectible carrier for the efficient disposal of debris such as drywall and plaster.

2. Description of the Related Art

The transfer of residential and commercial real estate often involves improvement operations to increase the value of the property for sale or to put an older property in suitable condition for the new owner. Such improvement operations often involve the cutting, drilling or destruction of drywall or the removal of plaster-covered surfaces. Other operations include the removal of old or damaged tile and the disposal of nails and other unneeded fasteners. The creation of said debris during improvement operations requires its immediate removal.

Conventional means for the disposal of improvement operation debris are well known and include such devices as garbage bags and tarpaulins. However, both approaches for the disposal of debris have proved to be messy and cumbersome. Conventional disposal bags have a sack-like structure with a closed end and an open end. The open end receives the debris and is often secured by tying the closed end into a knot, using a drawstring type device or by utilizing a tying member. This configuration requires more time and effort. First, after an appreciable accumulation of debris, improvement operations would have to cease to remove the accumulation. This process would require the efforts of more than one individual, one person to hold the bag open and another person to place the debris inside the bag. Conventional bags are then required to be discarded to a location that is remote from the worksite requiring the assistance of more than one individual. This results in a waste of both time and monetary resources. Additionally, conventional disposal bags are typically single use items and are usually discarded along with the debris.

Tarpaulins or tarps are flat, sheet-like structures that are laid down to cover an entire work area and subsequently filled with debris during improvement operations. However, conventional tarps are undesirable. The use of oversized tarps to cover large work areas requires a large storage facility in which to maintain them. Moreover, large tarps cannot be filled to capacity due to the fact that it would be next to impossible to move without the assistance of a large workforce or heavy machinery.

### SUMMARY OF THE INVENTION

In view of the foregoing disadvantages inherent in the use of conventional debris disposal devices, the present invention provides a new and improved apparatus and method for collecting debris.

The general purpose of the present invention, which will be described subsequently in greater detail, is to provide a debris collection device that does not suffer from the disadvantages mentioned heretofore.

The device generally comprises a substantially flat sheet having a rectangular or square shape and further comprising a first side, a second side, a third side and a fourth side. The flat sheet also includes an expanding pouch member located in the center thereof. Each side of the flat sheet is substantially identical and comprises at least one handle, at least one connecting device, a lower overhang strip and an upper overhang strip.

There has thus been rather broadly described the more important features of the novel device so that the detailed descript that follows will be better understood and the contribution to the field of debris removal better understood.

Before explaining at least one embodiment of the novel device in detail, it is to be understood that the device is not limited in its application to the details neither of construction nor of the configurations set forth in the following description or the illustrated drawings. The novel device is capable of other embodiments and of being practiced and carried out in other ways.

It is therefore an object of the invention to provide a new and improved debris carrier that is easy to use.

It is another object of the invention to provide a new and improved debris carrier that is makes the improvement operation more efficient by saving the user trips to the dumpster and, therefore, money spent on labor.

It is a further object of the invention to provide a new and improved debris carrier that is reusable.

It is a further object of the invention to provide a new and improved debris carrier that is detachably connectible to other similar debris carriers.

Still yet another object of the invention is to provide a new and improved debris carrier that is lightweight yet durable in construction.

Yet another object of the invention is to provide a new and improved debris carrier that is easily and inexpensively manufactured.

Other objects of the invention are pointed out with particularity in the claims annexed hereto and forming part of the disclosure. For a better understanding of the invention, its operating advantages and the specific objects attainted by its uses, reference should be made to accompanying drawings and descriptive matter in which there are illustrated preferred embodiments of the invention.

### BRIEF DESCRIPTION OF THE DRAWINGS

FIG. 1 shows details of the top side of an embodiment of the elements of the woven fiber connectible debris carrier.

FIG. 2 shows details of the bottom side of the woven fiber connectible debris carrier of FIG. 1.

FIG. 3 shows a perspective view of the woven fiber connectible debris carrier of FIG. 1.

FIG. 4 is a reduced view showing the manner in which a plurality of debris carriers of FIG. 1 releasably connected to one another.

### DESCRIPTION OF THE INVENTION

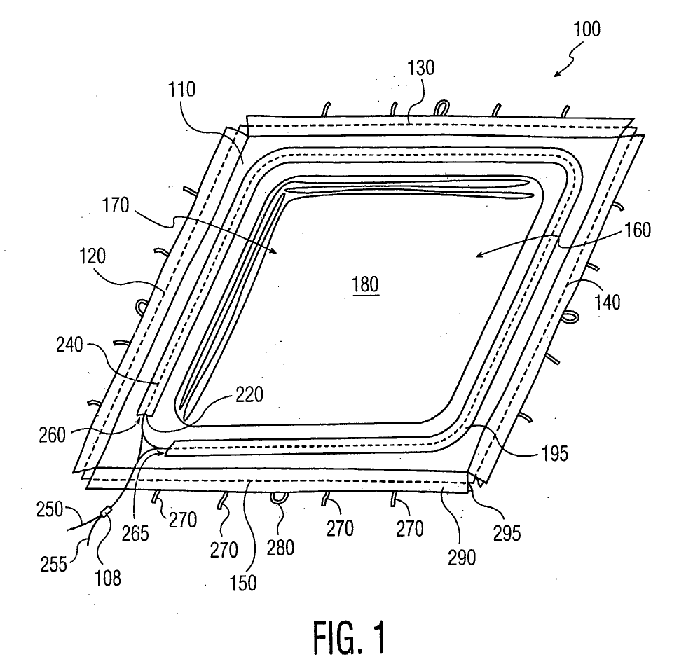

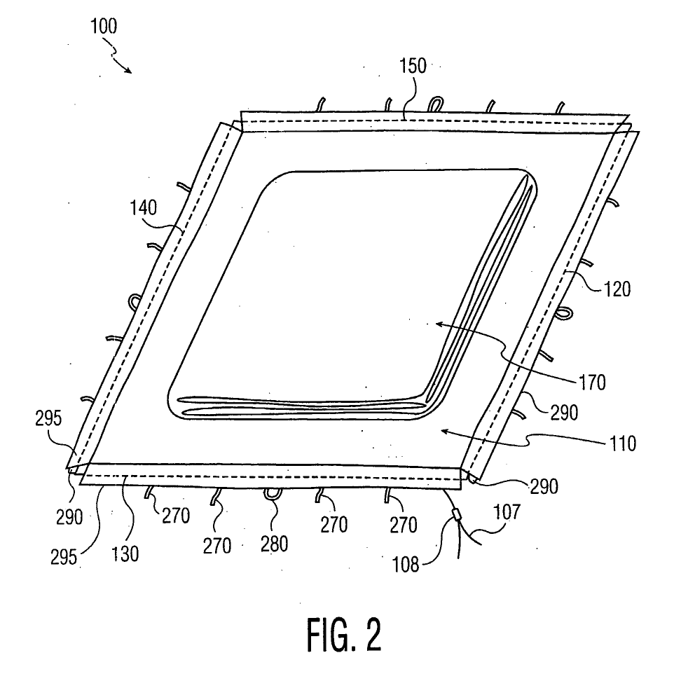

Turning now to the drawings, in which similar reference character denote similar elements throughout the several views, FIGS. 1 TO 3 disclose a debris carrier generally indicted at 100. The carrier 100 includes a generally square or rectangular sheet 110 having a first peripheral edge 120, a second peripheral edge 130 a third peripheral edge 140 and a fourth peripheral edge 150. An expanding pouch 170 is centered within the boundaries of the rectangular sheet 110.

The sheet 110 is a broad flat structure that may be formed of any size and any desired material. For example, the sheet 110 may be made of natural or synthetic fibers or of continuous sheet material such as plastic. Preferably, the sheet 110 is made of woven plastic fiber. The sheet 110 may be of any desired size and is generally rectangular or square in shape for ease of manufacture. The sheet 110 further includes a centrally located opening 160. The opening 160 can be any shape but is generally rectangular or square to complement the shape of the sheet 110.

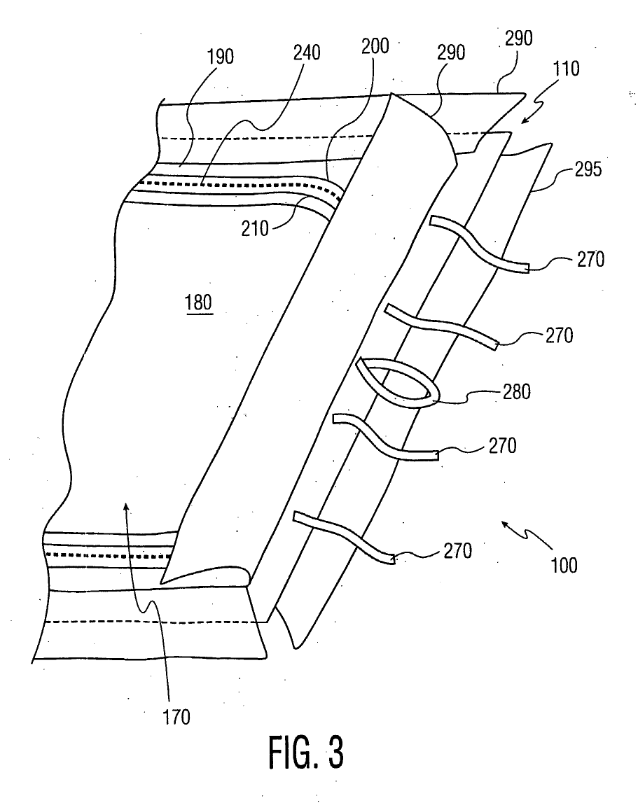

As best shown in FIGS. 1 and 3, sheet 110 further includes an expanding pouch member 170. The expanding pouch member 1701 is a three-dimensional member having a length, a width and a height that extends downward in a direction perpendicular to a flat plane that is coincident with a plane formed by sheet 110. Referring to FIG. 3, this configuration creates an open receptacle area 180. The expanding pouch member 170 is made from flexible materials similar to that of the flat sheet, namely, natural or synthetic fibers or of continuous sheet material such as plastic. Preferably, the expanding pouch member 170 is made of woven plastic fiber. Alternatively, the expanding pouch member 170 is comprised of a reinforced material to resist puncture from sharp instruments such as nails and glass. Expanding pouch member 170 is attached to the sheet member 110 by any suitable means such as with the use of an adhesive or by stitching. These means for attaching are examples only since any suitable means known in the art can be used.

Referring to FIG. 1, the carrier 100 further includes a dual layered strip 190 that extends just inside the entire periphery of the sheet member 110 to define a drawstring casing 195. The dual layered strip 190 has a first longitudinal edge 200 and a second longitudinal edge 210. Each longitudinal edge 200, 210 is secured to the sheet member by any means known in the art such as stitching or the use of an adhesive. Securing just the first and second edges 200, 210 create a pocket 220 there between. As shown in the drawings, the path of the strip 190 begins at a first corner and travels to each other corner about the periphery of the sheet member 110 until it reaches just short of its starting point at the first corner.

A cord or drawstring 240 is received in the drawstring casing 195 in either open end as is known in the art and is of sufficient size to extend about the periphery of the sheet member 110 as shown in FIG. 1. The drawstring 240 is freely and slidably received in the drawstring casing 195 so that its movement is substantially unrestricted. Preferably, the drawstring is endless with a first portion 250 of the drawstring 240 extending past a first opening 260 of the drawstring casing 195 and a second portion 255 extending past a second opening 265 of the drawstring casing 195. The first and second portions 250 and 255 are always accessible through their respective openings 260 and 265. First and second portions 250 and 255 may be secured together by a fastener 108 such as a spring loaded clip

As discussed above, the carrier 100 has four sides 120, 130, 140 and 150 that are substantially similar to one another. Because each side is substantially similar, only one side will be discussed for purposes of illustration. Referring to FIG. 3 of the drawings, there is shown at least one side having a plurality of flexible elongate members 270. The flexible elongate members 270 are essentially strings which are securely attached to sheet member 110. Suitable means for attaching elongate members 270 include stitching, tying or the use of an adhesive. While only four elongate members 270 are shown in FIG. 3, it is to be understood that any number of elongate members 270 may be used.

Each peripheral edge 120, 130, 140 and 150, further includes a grab strap or handle 280. Handle 280 is essentially a thickened piece of woven fiber in the shape of a loop. However, it is to be understood that the handle 280 can be made of other materials and have other configurations. For example, handle 280 may be made of metal or plastic and have a substantially U-shape. The handle 280 can be attached by any means such as stitching, gluing or stapling. Preferably, each handle 280 is centered along the lines of the sheet member 110 as shown in FIG. 1, however, the handles 280 may be positioned along various other locations of the sheet member.

The debris carrier further includes upper and lower overhang members 290 and 295 that are located on each peripheral edge 120, 130, 140 and 150. The upper overhang member 290 is a strip of material located on a first side of sheet member 110 and is attached to the sheet at an edge or close thereto. Upper overhang member 290 extends substantially the entire length of one side of the sheet member 110. As can best be seen in FIG. 3, the overhang member 290 extends a distance past the edge of sheet member 110 to effectively increase the surface area of woven carrier 100. On the opposite side of sheet member 110 is located the second overhang member. Lower overhang member 295 substantially complements the upper overhang member 290 in both material and position on sheet member 110.

In use as a single unit, a user selects a debris carrier and places it on a flat surface such as the ground or a building floor in the position as shown in FIG. 1. After positioning the carrier on the flat surface the user then proceeds to fill the carrier 100 with a volume of debris by placing said debris in the area of the expanding pouch member 170. When a manageable volume of debris has been deposited on the carrier 100, the user will grasp handles 280 and pull them toward one another to gather the debris to the center of the carrier 100. The user then proceeds to lift the handles 280 in an upward direction causing the carrier 100 to transform from a flat member to a three-dimensional sack-like structure and allowing the debris to settle at the bottom of the expanding pouch member 170. The user then secures the debris by pulling the ends of the drawstring 240 taut. The debris carrier 100 will can then be carried away for disposal.

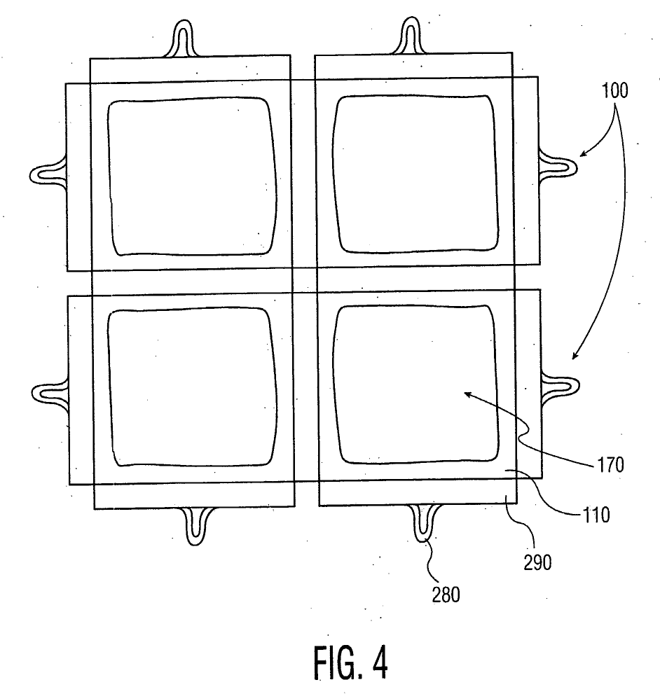

One can also readily recognize an additional advantage of the debris carrier 100. As can be shown in FIG. 4, when it is desired to cover an area larger than that covered by a single debris carrier 100, the user simply places a plurality of carriers 100 along a flat surface so that their respective edges are substantially in line with one another. The carrier can then be held together by tying an elongate member 270 of a first carrier 100 to a complimentary elongate member 270 of an opposing carrier. Once each elongate member 270 is removably attached to a complimentary elongate member, upper and lower overhang members 290 and 295 of each carrier 100 are made to lay flat and overlap one another. In this configuration, the overhang members 290 and 295 cover any gaps that may be present between adjacent carriers 100. From the forgoing, it is apparent that a debris disposal system of almost unlimited size can be created by joining together any number of debris carriers 100.

The forgoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A carrier for the disposal of debris during improvement operations, comprising:
a flat sheet-like member, the sheet-like member including,
a first peripheral edge, a second peripheral edge joined to the first peripheral edge, a third peripheral edge joined to the second peripheral edge and a fourth peripheral edge joined to the third peripheral edge;
wherein each peripheral edge is configured to selectively adhere to a peripheral edge of a substantially similar additional debris carrier such that a seal against particulate matter between the carriers is formed.

2. The carrier of claim 1, wherein each peripheral edge further includes at least one handle attached thereto.

3. The carrier of claim 1, wherein each peripheral edge further includes a plurality of elongate members for selectively adhering to said debris carrier to said additional debris carrier.

4. The carrier of claim 1, further including a drawstring that travels about the periphery of said flat sheet-like member to close said open receptacle area.

5. The carrier of claim 1, wherein each peripheral edge further including an upper overhang member located on an upper surface of the sheet member, the upper overhang member being a strip of material that extends substantially the longitudinal length of the edge and extends in a lateral direction a distance past the edge.

6. The carrier of claim 4, wherein each peripheral edge further including a lower overhang member located on a lower surface of the sheet member, the lower overhang member being a strip of material that extends substantially the longitudinal length of the edge and extends in a lateral direction a distance past the edge.

7. The carrier of claim 5, wherein the upper overhang member and the lower overhang member cooperate to seal any interspaces between the carrier and additional carriers against particulate matter moving there between.

8. The carrier of claim 1, further including a centrally located extending pouch, such that in a first position a planar surface of the extending pouch is substantially coincident with a surface of the flat sheet-like member, and in a second position the surface of the planar surface of the extending pouch is separated from the surface of the flat sheet-like member by a distance thereby forming an open receptacle area for the receipt of debris.

9. A method of debris disposal, comprising:
providing at least one debris carrier, the debris carrier comprising:
a flat sheet-like member, the sheet-like member including,
a first peripheral edge, a second peripheral edge joined to the first peripheral edge, a third peripheral edge joined to the second peripheral edge and a fourth peripheral edge joined to the third peripheral edge;
wherein each peripheral edge is configured to selectively adhere to a peripheral edge of a substantially similar additional debris carrier such that such that a seal against particulate matter between the carriers is formed;
situating the at least one debris carrier upon a surface area in which debris disposal will be required;
placing debris material on said debris carrier;
disposing of said debris material.

10. The method of claim 9, wherein the step of situating the at least one debris carrier upon a surface further includes the step of selectively adhering additional debris carriers to said at least one debris carrier.

11. The method of claim 9, wherein the step of selectively adhering additional debris carrier is performed by attaching elongate members of any peripheral edge of said debris carrier with elongate members of an adjacent peripheral edge of said additional debris carriers.

12. The method of claim 9, wherein the step of selectively adhering additional debris carriers further include the step of sealing any interspaces between said debris carrier and said additional debris carriers from particulate matter.
